(19) United States
(12) Patent Application Publication
(10) Pub. No.: US 2014/0156031 A1
(43) Pub. Date: Jun. 5, 2014

(54) Adaptive Stochastic Controller for Dynamic Treatment of Cyber-Physical Systems

(71) Applicant: The Trustees of Columbia University in the city of New York, New York, NY (US)

(72) Inventors: Roger N. Anderson, New York, NY (US); Albert Boulanger, New York, NY (US); Leon L. Wu, New York, NY (US); Kevin Mclnerney, New York, NY (US); Timothy Teravainen, New York, NY (US); Bibhas Chakraborty, New Brunswick, NJ (US)

(73) Assignee: The Trustees of Columbia University in the city of New York, New York, NY (US)

(21) Appl. No.: 14/177,020

(22) Filed: Feb. 10, 2014

Related U.S. Application Data
(63) Continuation of application No. PCT/US2012/050439, filed on Aug. 10, 2012.
(60) Provisional application No. 61/522,590, filed on Aug. 11, 2011.
(60) Provisional application No. 61/523,111, filed on Aug. 12, 2011.

(51) Int. Cl. G05B 13/04

(52) U.S. Cl. CPC G05B 13/04
USPC 700/29

(57) ABSTRACT

Techniques for generating a dynamic treatment control policy for a cyber-physical system having one or more components, including a data collector for collecting data representative of the cyber-physical system, and adaptive stochastic controller including one or more models for generating a predicted value corresponding to available actions based on an objective function, and an approximate dynamic programming element configured to receive actual operation metrics corresponding to the available actions. The approximate dynamic programming element can learn a state-action map and generate a dynamic treatment control policy using the one or more models.

### CROSS-REFERENCE TO RELATED APPLICATIONS

This application is continuation of PCT/US12/050,439, filed Aug. 10, 2012, and related to U.S. Provisional Application Ser. No. 61/522,590, filed on Aug. 11, 2011, and U.S. Provisional Application Ser. No. 61/523,111, filed on Aug. 12, 2011, which are each incorporated herein by reference in their entirety and from which priority is claimed.

### STATEMENT OF FEDERALLY SPONSORED RESEARCH OR DEVELOPMENT

This invention was made with government support under Grant no. OE-OE0000197, awarded by the Department of Energy. The government has certain rights in the invention.

### BACKGROUND

The disclosed subject matter relates to techniques for controlling cyber-physical systems.

Management and control of cyber-physical systems can involve a complex array of decision-making variables that can affect various aspects of the system. For example, in the electric power industry, utility plant operating engineers and managers are faced with an array of decision making variables, arising from deregulated markets, technology change, multiple weather events, physical failure situations and supply anomalies, and now the specter of terrorist attacks across multiple power grids.

Power utilities generate electrical power at remote plants and deliver electricity to residential, business or industrial customers via transmission networks and distribution grids. Power can first be transmitted as high voltage transmissions from the remote power plants to geographically diverse substations. From the substations, the received power can be sent using cables or “feeders” to local transformers that further reduce the voltage. The outputs of the transformers can be connected to a local low voltage power distribution grid that can be tapped directly by the customers, such as in dense urban environments. The power distribution grids can be configured as either radial or networked systems. A radial distribution system can include a number of feeder circuits that extend radially from a substation. Each circuit serves customers within a particular area and the failure of a radial circuit cuts off electric service to the customers on that circuit.

In a networked distribution system, service can be provided through multiple paths (e.g., through multiple transformers) connected in parallel, as opposed to the radial system in which there can be only one path for power to flow from the substation to a particular load. A networked distribution system provides multiple potential paths through which electricity can flow to a particular load. By its nature, a networked distribution system can be more reliable than a radial distribution system. When a networked distribution system is properly designed and maintained, the loss of any single low or high voltage component usually does not cause an interruption in service or degradation of power quality. Network protection devices or switches can automatically operate to isolate the failed component. Networked distribution systems are installed in high-load density metropolitan areas (e.g., Chicago and New York City) that require reliable electricity service.

In metropolitan areas, feeders can run under city streets, and can be spliced together in manholes. Multiple or redundant feeders can feed, through transformers, the customer-tapped secondary grid, so that individual feeders can fail without causing power outages. For example, the electrical distribution grid of New York City is organized into networks, each composed of a substation, its attached primary feeders, and a secondary grid. The networks are electrically isolated from each other to limit the cascading of problems or disturbances. Network protection switches on the secondary side of network transformers can be used for isolation, as well as protect against overloads and prevent back feeds. Isolation switches can be installed on the primary network. The primary feeders can, for example, be critical and have a failure rate (i.e., a mean time between failures) of less than 1000 days, and in some instances 400 days.

Multiple or redundant feeders can feed the customer-tapped grid, so that individual feeders can fail without causing power outages. Each feeder can be coupled to a main breaker at the substation. The underground distribution network can effectively form at least a 3-edge connected graph, often referred to as a 2^{nd} contingency design—in other words, any two components can fail without disrupting delivery of electricity to customers. Many feeder failures result in automatic isolation—so called “Open Autos” or O/As. When an O/A occurs, the load that had been carried by the failed feeder must shift to adjacent feeders, further stressing them. O/As put networks, control centers, and field crews under considerable stress, especially during the summer, and cost millions of dollars in operations and maintenance expenses annually.

Providing reliable electric supply can require active or continuous “control room” management of the distribution system by utility operators. Real-time response to a disturbance or problem can, for example, require redirecting power flows for load balancing or sectionalizing as needed. The control room operators constantly monitor the distribution system for potential problems that can lead to disturbances. Sensors can be used to monitor the electrical characteristics (e.g., voltage, current, frequency, harmonics, etc.) and the condition of critical components (e.g., transformers, feeders, secondary mains, and circuit breakers, etc.) in the distribution system. The sensor data can guide empirical tactics (e.g., load redistribution in summer heat waves) or strategies (e.g., scheduling network upgrades at times of low power demand in the winter); and provide indications of unique or peculiar component life expectancy based on observations of unique or peculiar loads. In addition to sensor data, attribute data about the components that make up the feeders, such as type, manufacturer, specification code, and installation data, as well as electrical characteristics including the relationship to other feeders, is also available. Additionally or alternatively, attribute data about the mains, such as make, model, capacity, age of the main, and the like can also be available, as well as data related to the topology of the secondary network, e.g., betweenness centrality.

Autonomous control systems for field operations such as at electric utilities, e.g., for the Smart Grid, can be developed for control and management of cyber-physical systems. Conventional systems and methods for supporting decision-making can deal with complexity by hierarchal decomposition. That is, different modules of a cyber-physical system can be partitioned and organized. The hierarchal decomposition approach, however, can lead to gaps, missed synergies, or common mode interactions, which can affect the efficiency of the cyber-physical system.

Accordingly, there is a need for improved devices and methods for control and management of cyber-physical systems.

### SUMMARY

In one aspect of the disclosed subject matter, a system for generating a dynamic treatment control policy for a cyber-physical system having one or more components is provided. The system can include a data collector to collect data representative of the cyber-physical system. An adaptive stochastic controller can be operatively coupled to the data collector and can include one or more models for generating a predicted value corresponding to one or more available actions based on an objective function. An approximate dynamic programming element can be configured to receive one or more actual operation metrics corresponding to one of the available actions and configured to adjust the one or more models using the actual operation metrics.

In some embodiments, the data collector can include a receiver for receiving outage derived data sets (ODDS), and the collected data can include one or more of static data about the components, dynamic external data, and dynamic data about the components. In some embodiments, the “components” can include, for example, components that can be replaced in a repairable system, such as a whole feeder.

In some embodiments the objective function can be mean time between failure (or failure rate) and the one or more models for generating a predicted value can include a model for generating a predicted mean time between failures (or failure rate) for each component of the cyber-physical system. In certain embodiments, the failure rate model can be a semiparametric model. Alternatively, the model can use a measure of system reliability for a particular component given by the difference in failure rates. In connection with certain embodiments, variants of mean time between failures can be employed, such as failure rate or difference in failure rate. Moreover, instantaneous failure rate, e.g., hazard rate, can be predicted.

In some embodiments the one or more models can include a propensity model for inverse propensity weighting. For example, components with a history of being restored without actions taken by the controller, or that are subject to “independent treatment” can be “handicapped.” As described herein, predicting a “baseline” result relative to the available actions can refer to a propensity model for inverse propensity weighting. The one or more models can include a learning system for learning behavior of the cyber-physical system and adjusting the one or more models using the one or more actual operation metrics.

In some embodiments the approximate dynamic programming element can be configured to adjust the one or more models using a Q-learning for comparison of the predicted value and the one or more actual operation metrics. The approximate dynamic programming element can include a learning system for learning behavior of the cyber-physical system and for adjusting the approximate dynamic programming element using the one or more actual operating metrics.

In some embodiments, the available actions can include repairing, replacing, or choosing not to repair or replace one or more components of the cyber-physical system.

The disclosed subject matter also provides methods for generating a dynamic treatment control policy for a cyber-physical system having one or more components. In one example, a method includes generating a predicted value corresponding to one or more available actions based on an objective function and one or more models using data representative of the cyber-physical system. One or more actual operation metrics can be received at an approximate dynamic programming element. The actual operation metrics can correspond to the one or more available actions. For example, the actual operation metrics can be collected aver an available action has been executed, and can reflect the state of the system after such action was taken. The one or more models can be adjusted with the approximate dynamic programming element using the actual operation metrics.

In some embodiments one or more propensity models can be used to math or weight a component, such as mains or switches. For example, the propensity model can be used for inverse propensity weighting. In some embodiments the method can include learning behavior of the cyber-physical system and additionally or alternatively adjusting the one or more models accordingly using a reinforcement learning algorithm and the one or more actual operation metrics. In some embodiments a Q-learning algorithm for comparison of the predicted value and the one or more actual operations metrics can be used in adjusting a state-action map that can learn which actions improve reliability as measured by the difference in failure rate before and after the action was executed.

### BRIEF DESCRIPTION OF THE DRAWINGS

FIG. 1 is a block diagram of a system for control and workflow management of a cyber-physical system in accordance with the disclosed subject matter.

FIG. 2 is a block diagram of a system for control of a cyber-physical system in accordance with an embodiment of the disclosed subject matter.

FIG. 3 is a flow diagram of a method for control of a cyber-physical system in accordance with an embodiment of the disclosed subject matter.

FIG. 4 is a block diagram of a system for generating a dynamic treatment control policy for a cyber-physical system in accordance with an embodiment of the disclosed subject matter.

FIG. 5 is a schematic representation of an exemplary architecture of a system for generating dynamic treatment control policies for a cyber-physical system in accordance with an embodiment of the disclosed subject matter.

FIG. 6 depicts an exemplary outage derived data set in accordance with an embodiment of the disclosed subject matter.

FIG. 7 illustrates an approximate dynamic programming learning methodology in accordance with an embodiment of the disclosed subject matter.

Throughout the drawings, the same reference numerals and characters, unless otherwise stated or indicated by context, are used to denote like features, elements, components or portions of the illustrated embodiments. Moreover, while the disclosed subject matter will now be described in detail with reference to the Figs., it is done so in connection with the illustrative embodiments.

### DETAILED DESCRIPTION

Electric utilities operate in environment that is dominated by stochastic (statistical) variability, primarily driven by the vagaries of the weather and by equipment failures. Within the Smart Grid, advanced dynamic control can be employed for simultaneous management of real time pricing, curtailable loads, electric vehicle recharging, solar, wind, and other distributed generation sources, many forms of energy storage, and microgrid management.

Computationally, controlling and managing the Smart Grid is a multistage, time-variable, stochastic optimization endeavor. Adaptive Stochastic Control (ASC) using approximate dynamic programming (ADP) can offer the capability of achieving autonomous control using a computational learning system to manage the Smart Grid. Within the complexities of the Smart Grid, ADP driven ASC, such as disclosed in U.S. Pat. No. 7,395,252, which is hereby incorporated by reference in its entirety, can be used as a decomposition strategy that breaks the problem of continuous Smart Grid management, with its long time horizons, into a series of short-term problems that a Mixed-Integer Nonlinear Programming (MINLP) or, for example, a LP solver with integer constraints if the problem is linearized, can handle with sufficient speed and computational efficiency to make it practical for system-of-systems control.

In one aspect of the disclosed subject matter, a system for generating a dynamic treatment control policy for a cyber-physical system is provided. In another aspect of the disclosed subject matter, a method for generating a dynamic treatment control policy for a cyber-physical system having one or more components is provided. As used herein, the term “dynamic treatment” can include mitigating electrical and mechanical stresses on components of a cyber-physical system to increase service life and reduce the probability of multiple contingency failures; prioritizing maintenance investments and investment timing on components of the cyber-physical system to reduce mean time between failures; and performing preventative maintenance and inspections and their timing.

As used herein, the term “cyber-physical system” can include any system in which dynamic treatment can be performed, for example a smart electrical grid. For purposes of illustration and not limitation, the disclosed subject matter will be described in detail herein in the context of a smart electrical grid. However, one of ordinary skill in the art will appreciate that the techniques disclosed herein are applicable to other cyber-physical systems, such as a collection of industrial equipment, a collection of components of a building, a network of computers or computer components, components of transportation, distribution, or other infrastructure, components of systems for telecommunications, water, gas, oil, sewage or the like.

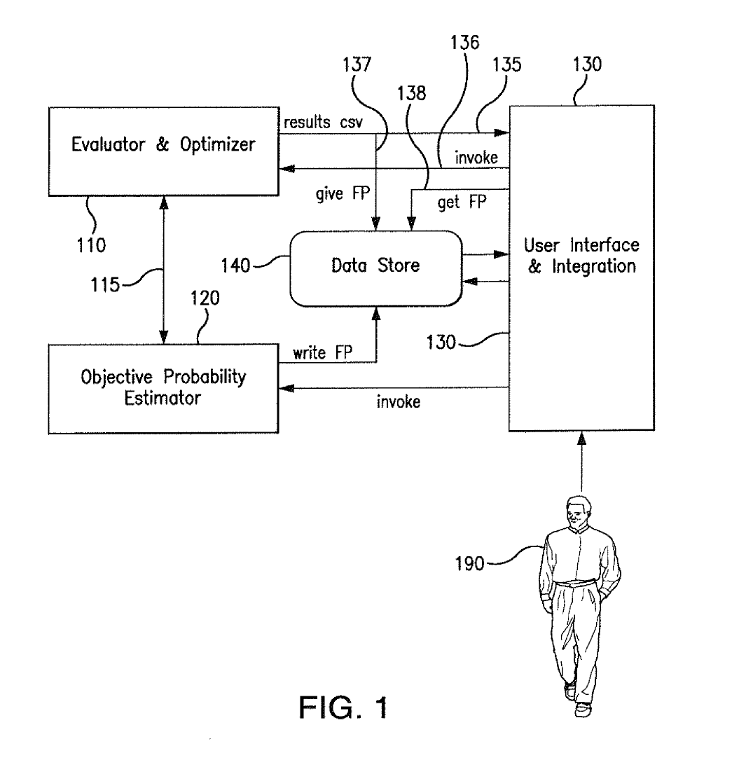

For purpose of illustration and not limitation, and with reference to FIG. 1, an exemplary system for controlling and managing workflow in a cyber-physical system can include a user interface 130 integrated with and operatively coupled to a number of modules. For example, the user interface 130 can be coupled to an evaluator and optimizer 110, an objective probability estimator 120, and a data store 140.

For example, the user interface 130 can be configured to communicate with the evaluator and optimizer 110 so as to receive results 135 and send data 136 which can be obtained from the data store 140. In like manner, the user interface 130 can be configured to communicate with the data store 140 to send and receive data, e.g. failure probability prediction (FP) data 138 and 137. Additionally, the user interface 130 can be configured to invoke the objective probability estimator 120. The objective probability estimator 120 can be operatively connected, for example via a wired, wireless, or flat file communication protocol 115, with the evaluator and optimizer 110. A user 190 can operate and interact with the user interface 130 to facilitate control and management of the cyber-physical system. As described in more detail herein, the modules 110 and 120 can be selected based on a desired task. The task can be, for example, dynamic treatment control of a cyber-physical system.

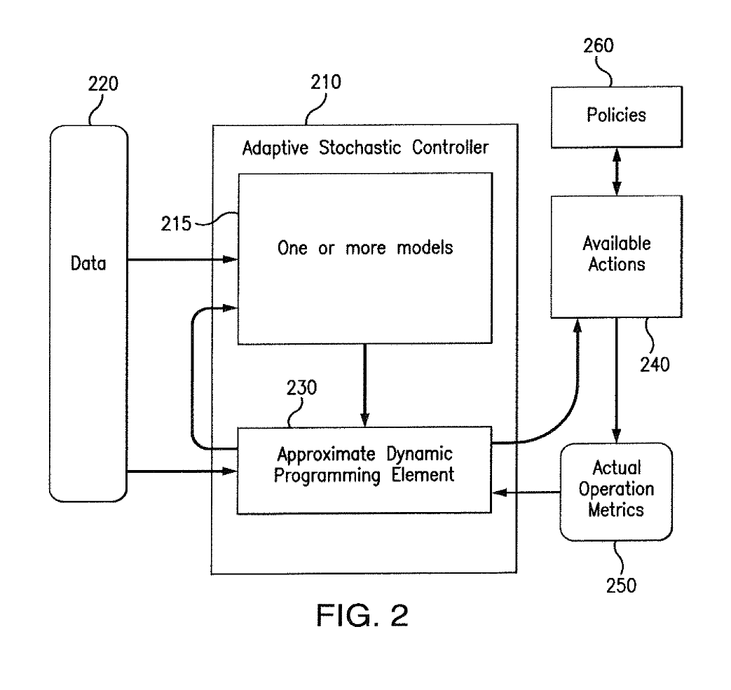

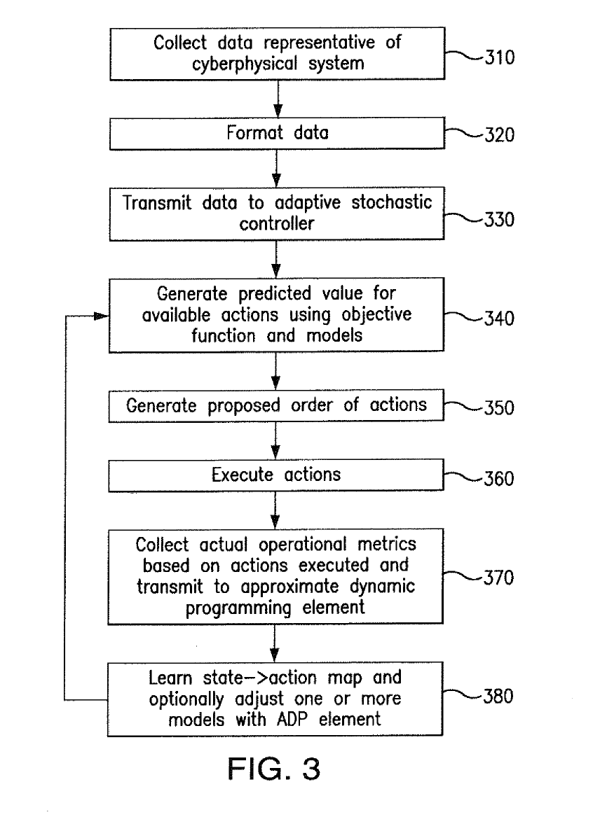

Particular embodiments of the system and method are described below, with reference to FIG. 2 and FIG. 3, for purpose of illustration and not limitation. For purpose of clarity, the method and system are described concurrently and in conjunction with each other.

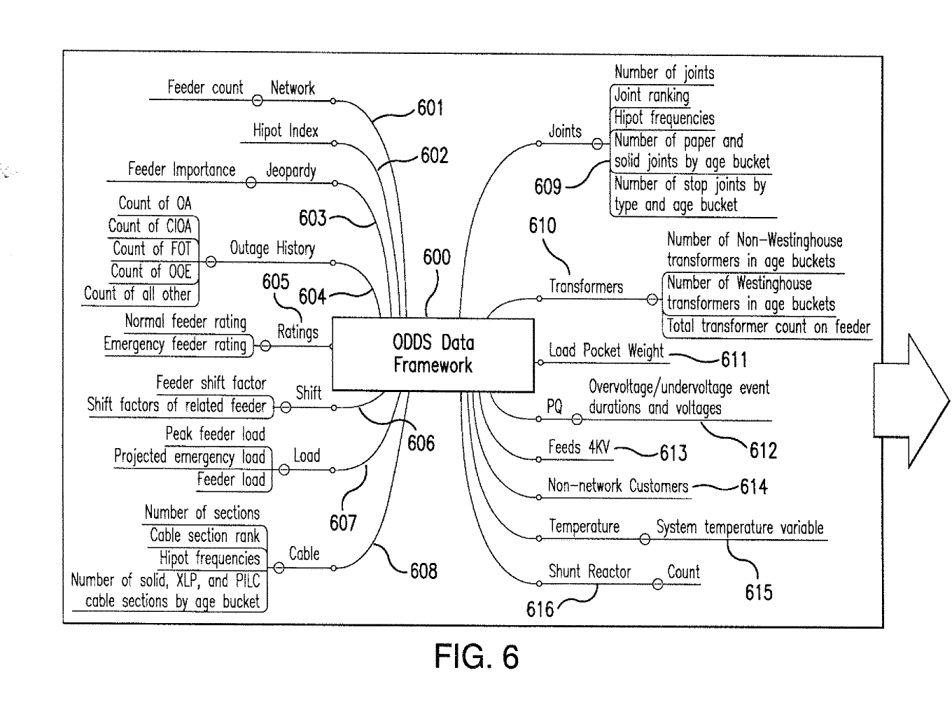

In one embodiment, and with reference to FIG. 2 and FIG. 3, data representative of a cyber-physical system 220 can be collected (310). Data 220 can include, for example, real time data or dynamic data and static data. Additionally or alternatively, data 220 can include dynamic external data, such as weather data, forecasted weather data, and the like. In certain embodiments, the data 220 can be processed and formatted (320). For example, the data 220 can be formatted using an outage derived data set framework 600, as described in more detail below with reference to FIG. 6. As used herein, the term “outage derived data set” (ODDS) can include dynamic data coming from the cyber-physical system combined with static information about the history of components of the cyber-physical system.

The data 220 can be stored, for example, in one or more databases. For example, the data 220 can be collected (310) with a data collector, which can include a computer programmed to interface with and receive the data internally from the cyber-physical system or from a remote system. That is, the cyber-physical system or a remote system can transmit (330) the data to the data collector, which can then store the data 220 in a database.

An adaptive stochastic controller 210 can be operatively coupled to the data collector and adapted to receive collected data 220 from the data collector. That is, the data 220 can be transmitted (330) from the data collector to the adaptive stochastic controller. As used herein, the term “adaptive stochastic controller” can include a controller that can simulate multiple potential future outcomes in order to quantify uncertainty and adapt desired actions and policies. For example, as described herein, an adaptive stochastic controller can use approximate dynamic programming to predict emerging problems and recommend operational actions to enhance performance, and can include verification of one or more predictive models. Further, as described herein, an adaptive stochastic controller can auto-correct and employ machine learning to modify actions taken on the system over time as external forces change. That is, for example, an adaptive stochastic controller can measure cause-and-effect and adjust learning accordingly. The adaptive stochastic controller 210 can include, for example, an innervated stochastic controller such as disclosed in U.S. Pat. No. 7,395,252. Additionally or alternatively, the adaptive stochastic controller 210 can include a machine learning and/or statistical modeling element. For example, the adaptive stochastic controller 210 can include a machine learning element employing martingale boosting such as disclosed in U.S. Pat. No. 8,036,996, which is hereby incorporated by reference in its entirety.

As disclosed herein, the adaptive stochastic controller 210 can include one or more models 215 for generating (340) a predicted value corresponding to one or more available actions 240 based on an objective function. Additionally, the adaptive stochastic controller 210 can include an approximate dynamic programming element 230. The approximate dynamic programming element 230 can be configured to receive one or more actual operation metrics 250 corresponding to one of the available actions 240. Additionally, the approximate dynamic programming element 230 can be configured to adjust (380) the one or more models 215 using the actual operation metrics 250.

In certain embodiments, the one or more models 215 of the adaptive stochastic controller 210 can include a power flow model, a transformer load variance model, an unknown open main model, Monte Carlo failure simulations, and/or machine learning mean time between failure prediction and/or ranking models. The one or more models 215 can further include a dynamic treatment model configured to generate (350) a proposed action or sequence of available actions 240 to enhance mean time between failure rating, as well as a propensity model to match or weight components. Such actions can include, for example, repairing, replacing, or choosing not to or delay repair or replace one or more components of the cyber-physical system.

In certain embodiments, one or more of the proposed actions 240 can be executed (360). For example, the Approximate Dynamic Programming element 230 can generate a set of proposed actions 240 which can then be executed manually. Alternatively, such proposed actions can be executed in an autonomous manner. After an action 240 has been executed (360), actual operation metrics 250 of the cyber-physical system can be collected (370). The actual operation metrics 250 can include, for example, information regarding the state of the cyber-physical system, the components of the cyber-physical system, as well as external information. Moreover, the actual operation metrics 250 can include predictions as well as modeled data. For purpose of example and not limitation, the actual operation metrics 250 can include the Customer Average Interruption Duration Index (CAIDI) performance metric, which is a reliability index which can be used by electric power utilities, and the System Average Interruption Frequency Index (SAIFI) performance metric, which can be used as a reliability indicator by electric power utilities. SAIFI can be given by the number of interruptions that a customer would experience in units of interruptions per customer, and can be given over the course of a year. The actual operation metrics 250 can include data analogous to data 220. That is, data 220 can be a subset of the actual operation metrics 250.

The approximate dynamic programming element 230 can be configured to receive the actual operation metrics 250. The approximate dynamic programming element 230 can further be configured to adjust (380) the one or more models 215 based on the actual operation metrics 250 and the predicted value generated by the one or more models 215. For example, the one or more models 215 can be fed into an approximate dynamic programming algorithm to produce value functions for each of the systems state-action pairs, and thereby adjust the one or more models 215 to accurately reflect observed results.

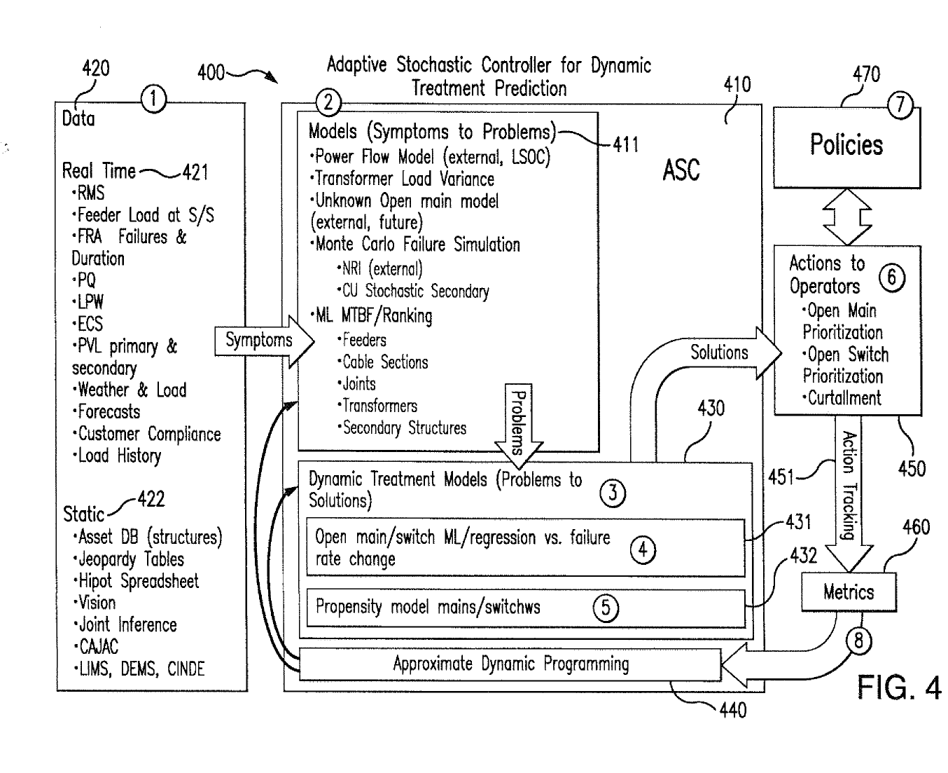

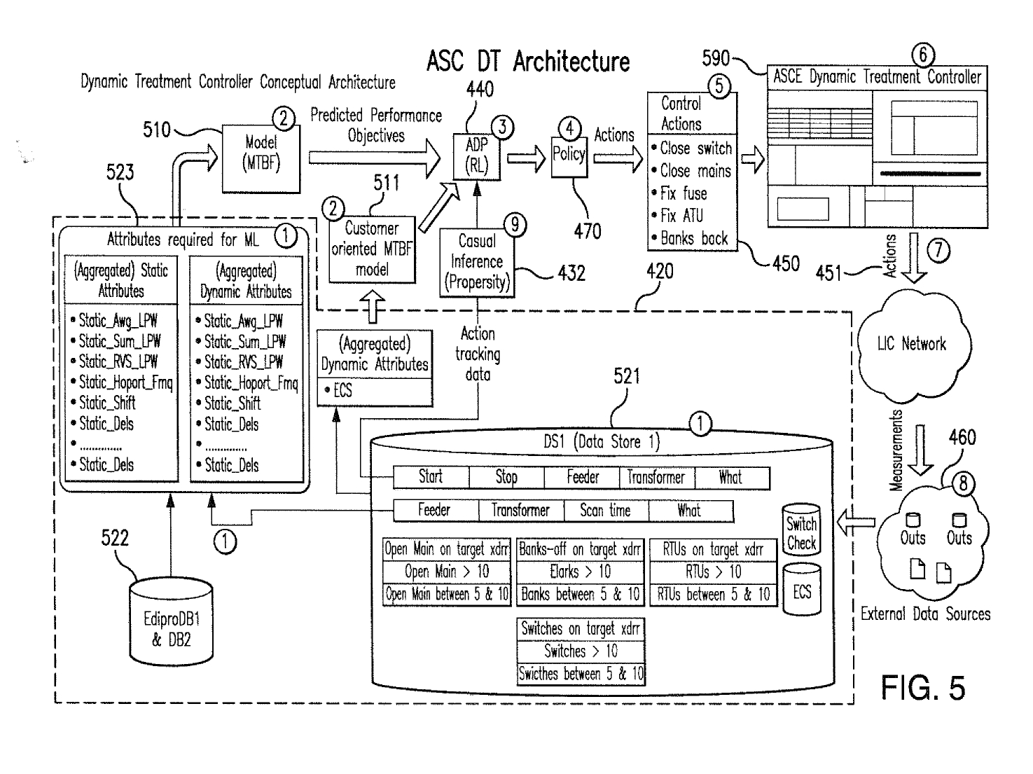

An exemplary embodiment of the disclosed subject matter will now be described in detail, for purposes of illustration and not limitation, with reference to FIG. 4, FIG. 5, and FIG. 6. In this exemplary embodiment, the cyber-physical system can be a smart electrical grid.

As described above, data 420 representative of a smart electrical grid can be collected. This data 420 can include, for example, real time data or dynamic data 421 and static data 422. In certain embodiments, for example, the real time data 421 can include Remote Monitoring System (RMS) data (e.g., data from a SCADA system for network transformers), Feeder Load as substation data, Failures & Duration (FRA) data, Power Quality (PQ) data, Load Pocket Weight (LPW) data, emergency call system (ECS) data, Poly Voltage Load flow (PVL) primary & secondary data (e.g., data about a specific type of cable), Weather & Load Forecasts, Customer Compliance data, and Load history data. In certain embodiments, for example, the static data 422 can include Asset DB structures, Jeopardy Tables, High Potential Test (HiPot) data, Cable (Vision) data, Joint data, CAJAC failure data (e.g., data about a distribution feeder component failures), and or LIMS, DBMS, and CINDE data (e.g., data about transformers and their inspection/testing). Additionally or alternatively, data 420 can include dynamic external data, such as weather data, forecasted weather data, and the like. The data 420 can include a data store 521, which can receive actual operation metrics 460. The data 420 can also be formatted 522 and prepared for transmission 523 to the one or more models 411 of the adaptive stochastic controller 410.

Also as described, above, data representative of a smart electrical grid 420 can be formatted, for example using an ODDS framework. For purpose of example and not limitation, and with reference to FIG. 6, ODDS data can include network data 601 which can include a count of the number of components of the cyber-physical system. The ODDS data can include Hipot data 602, which includes high potential test results. The ODDS data can include a Jeopardy metric 603, which can describe the relative importance of a component (e.g., a feeder) to failure of the whole system (e.g., the network). The ODDS data can include outage history data 604; ratings 605 of the components, including normal and emergency ratings; shift data 606, including component shift factor and shift factors of related components; load data 607, including peak component load, projected emergency load, and expected component load; and cable data 608, including data representative of cable components in the cyber-physical system. The ODDS data can further include joint data 609 which can include data representing the connections between components of the cyber-physical system; transformer data 610, including information about transformer components of the cyber-physical system; load pocket weight data 611; PQ data 612, including overvoltage and undervoltage event duration and voltage data; feeds 4 KV data 613; non-network coverage data 614; temperature data 615, and shunt reactor data 616.

The adaptive stochastic controller 410 can be configured for dynamic treatment. For example, the adaptive stochastic controller 410 can be configured for rapid response to changing system conditions in order to account for intermittent or distributed anomalies by addressing failure models that lead to changing risk evaluations. The adaptive stochastic controller 410 can, in a manner of speaking, consider both the “next worst events,” but also the “next most likely events” that can occur in the smart grid. Another dynamic aspect of the controller is that it can optionally incorporate a dynamically changing failure rate, which can be referred to as the “hazard rate,” which can address the changing conditions in the smart grid. A statistical or machine learning model, such as a Cox Proportional hazards model can provide a hazard rate.

The adaptive stochastic controller 410 can include one or more models 411 and 430 to make automated recommendations that operations personnel can act on to prevent future failures by, for example, replacing hardware that can lower the hazard rate of the grid. That is, the adaptive stochastic controller 410 can generate maintenance recommendations 450 that are predicted to improve the quality of electric service on the grid. The maintenance recommendations 450 can be, for example, closing transformer switches, repairing “Open Mains” (OM) in the secondary low voltage grid, and bringing transformer Banks Off (BO) back online. More particularly, and in connection with a particular embodiment, the adaptive stochastic controller 410 can be configured to determine which open mains within the secondary, low voltage grid to close based on predictions of how much improvement in feeder reliability would occur as measured by mean time between failure (MTBF) statistics. The maintenance recommendations 450 can be transmitted to, and displayed on, an operator dashboard 590.

An open main is a main that no longer has flowing power. For example, if an operator of a smart electrical grid detects a failed main, field personnel can employ a formal process to register it officially “open.” Both ends of the main can be cut by field workers, one at each manhole or service box where the main connects to the grid. The main can then be registered in an “open main database.” Additionally, the transformer that is electrically closest to the opened main can be recorded. However, due to high interconnectedness of components of the grid and the potential lack of monitoring, mains can fail silently—no longer flowing power but not interrupting service. Such “unknown open mains” can remain unfixed for long periods of time and can be discovered only when a periodic inspection is preformed. Additionally or alternatively, in some embodiments an open main by inferred, for example, using power flow, transformer load variance, or other suitable metrics.

In accordance with this exemplary embodiment, the objective function of the adaptive stochastic controller 410 can be, for example mean time between failures (MTBF) of one or more components of the electrical grid. That is, the one or more models can include a model 510 for generating a predicted mean time between failure for each component of the cyber-physical system. Alternatively, or in addition, one or more models can include a customer oriented MTBF model 511.

In one embodiment, one of the models 430 can be configured to calculate the predicted mean time between failure using a semiparametric model, such as disclosed in PCT Application No. PCT/US2012/033309, which is hereby incorporated in its entirety. For example, the semiparametric model can process the data 420 representative of the smart electrical grid to identify a set of components at risk and a set of times of treatment corresponding to a treatment event. A nonparametric component of the semiparametric model can be estimated with reference to the components of the system and the set of times of treatment. A hazard rate can be predicted at a given time with the semiparametric model. Thus, a multiplicative approach based on failure rate can be employed to predict MTBF.

In one embodiment, system reliability can be measured as the change in gradient of failures of feeders before and after the main or switch closing. Feeders can be ranked based on the effect closing associated mains or switches can have on that feeder. The model can include a machine learning algorithm trained on historical data about open main and switch closings, feeder failures, and feeder attributes. Additionally, the model can include principle component analysis (PCA) to simplify the feature space. Such a model can include the use of two regressions: a model of main and switch closings, and a model of the effect of closings.

For purposes of example and not limitation, the first regression model can be a logistic regression for generating probabilities of main and switch closing. Feeders can be weighted by the inverse of this probability. The second regression model can learn the causal effect of the closings on feeder failures. Various combinations of tuning parameters can be adjusted to obtain an enhanced combination.

For purposes of illustration and not limitation, a description will now be made of a model configured to calculate the predicted mean time between failure based on a gradient of failure rate for each component in accordance with an exemplary embodiment of the disclosed subject matter. Each open main can be associated with a feeder on a one-by-one basis, using the feeder recorded when the main was opened. For each feeder, there can exist a record of when the feeder has failed as a time series. Some period of analysis, e.g., t days, can be selected and the number n_{b} of failures occurring in the period t days prior to the date analysis can be counted. Additionally, the number nₐ of failures in the period t days after the date analysis. The measure of system reliability for that feeder can be given as the difference in gradients

$$\frac{{n}_{b}}{t} - \frac{{n}_{a}}{t} .$$

Because each open main can be approximately associated with a feeder on a one-by-one basis (e.g., because the mains make up a network, there are multiple transformers that can feed power to a main, but closeness can be used to create a relationship), the unit of analysis can be a main-feeder pair. Each main can be associated with the electrically closest transformer and it's linked feeder. Static feeder attributes can be used to assist in learning a “baseline” failure rate for a particular feeder, as discussed in more detail below. Data for each feeder-main pair can be gathered in a vector, v. The combination of all feeder-main pairs can produce a matrix M that can be used for machine learning. In addition to the attributes of each feeder and/or attributes of mains and data related to the topology of the network, two additional vectors can be recorded for learning purposes—a zero-one vector that records if a given main was closed (1) during the observation period or not (I), and a record of the failure rate gradient change for a feeder. In an alternative embodiment, switch-feeder pairs can be used rather than main-feeder pairs. For example, associating a switch, e.g., a network protector switch, can include directly associating a switch to a transformer which it protects, and associating the transformer with a feeder.

Vector v can be large, having for example over 200 components. In some circumstances it can be the case that |v|>k, where k is the number of mains closed. In such circumstances, the large feature space induced by v can prevent the regression algorithms from converging. In this case, PCA can be applied to M to get hack a new matrix M* in the new basis space induced by the PCA transformation. The principal components (PCs) can be returned in decreasing order by the amount of variance in M* covered by each PC. PCs sufficient to cover 70% of the variance in M* can be chosen and the rest can be discarded, producing a new matrix M′. M and M* can be set aside and all analysis can be performed on M′, and the smaller feature space of M′ can allow for easier convergence even when there are few mains to learn from.

Additionally, in connection with an exemplary embodiment, one of the models can include a propensity model 432 for inverse weighting of components with a history of independent treatment. Independent treatment can include, for example, a scenario in which an open main would be closed without intervention from the system disclosed herein. Additionally or alternatively, independent treatment can include, for example, a scenario in which a condition of a component is remedied by environmental or other external factors without intervention from the system disclosed herein. In certain circumstances, prediction of an objective in a cyber-physical system can be complicated by extraneous variables. For example, predicting MTBF for components of the grid can be complicated by the probability that a main is closed by field operations independent of the controller—i.e., that a given main will be closed without taking any action by the controller. To account for these potential complications, a propensity score can be determined based on static attributes of each main and the static and dynamic attributes of each main's associated feeder.

The propensity model 432 can be calculated using logistic regression to obtain a regressed propensity score for each feeder. These scores can be used in determining an inverse propensity weighting. For example, for each main, the regressed propensity score can be called and the main's covariate vector can be weighted fully if the main was closed; otherwise, the mains' covariate can be partially weighted. Such a technique can address confounding factors in the adaptive stochastic controller 410. That is, such a technique can accommodate the lack of control groups where closing the main would not occur by other than the controller's suggested closings.

The propensity model 423 can, for example, be described as follows: the propensity score can be given by p:=Pr(A₁=1|S). Each observation can be weighted by the inverse of p if there is an open main; otherwise by inverse of (1−p). After weighting, a ranking model can be computed, given by Y=β₀+β₁^{T}S+(β₂+β₃^{T}S)*A, where T indicates the transpose of a vecto and where A=1 if an open main was closed, and A=0 otherwise. Y can be given as:

$$y = \frac{\# fdr failures before}{time before} - \frac{\# fdr fialures after}{time after} \qquad ( 1 )$$

After propensity weighting, S can be a state vector combining dynamic and static feeder attributes with static main attributes. Principle Component Analysis (PCA) can be applied to S to shrink it to a smaller, more manageable vector prior to applying the formula. Y, the response variable, can be, for example, the change in gradient of feeder failures before and after the main is closed. However, this formula can be employed in any general “change in quality” response variable Y, including the gradient or MTBF. Thus, the estimated causal effect can be given by

{c:=\hat{β}₂+\hat{β}₃^{T}S},
and rank can be based on max{0, c}.

The results of the regression used in connection with the propensity model 432 can be fed into the approximate dynamic programming element 440. The approximate dynamic programming element 440 can, for example, employ an approximate, parameterized Q-learning algorithm to produce value functions for each of the grid's state-action pairs. For example, a previously learned matrix model of change in MTBF gradient, M′, can be taken as input. The starting state can be the list of currently open mains in the grid. Recently closed mains can be added to obtain a list for each feeder for a given day. The predicted change in MTBF gradient can then be calculated, which can become the value of the starting state. Given a list of all feeders and their attributes, a score can be calculated for each proposed open main if it were to be closed. The sum over all feeders can be the reward r of taking this action in this state. The new state can be a set of open mains minus the one that was just recommended for closure.

A number of methods 470 can be implemented in connection with the approximate dynamic programming element 440. For example, a “greedy” learning method can be implemented so as to yield the best reward, r, in the current context of the learning being done. Using such a “greedy” learning method, the approximate dynamic programming element 440 can habitually choose the most rewarding action in the short term—that is, it can settle on a local equilibrium. However, in certain circumstances, there can be better rewards in the long run elsewhere. As such, the dynamic programming element 440 can implement an “ε-greedy” method, in which the approximate dynamic programming element 440 randomly chooses something other than the predicted optimal a proportion ε of the time. This can allow the algorithm a chance to search for a global equilibrium.

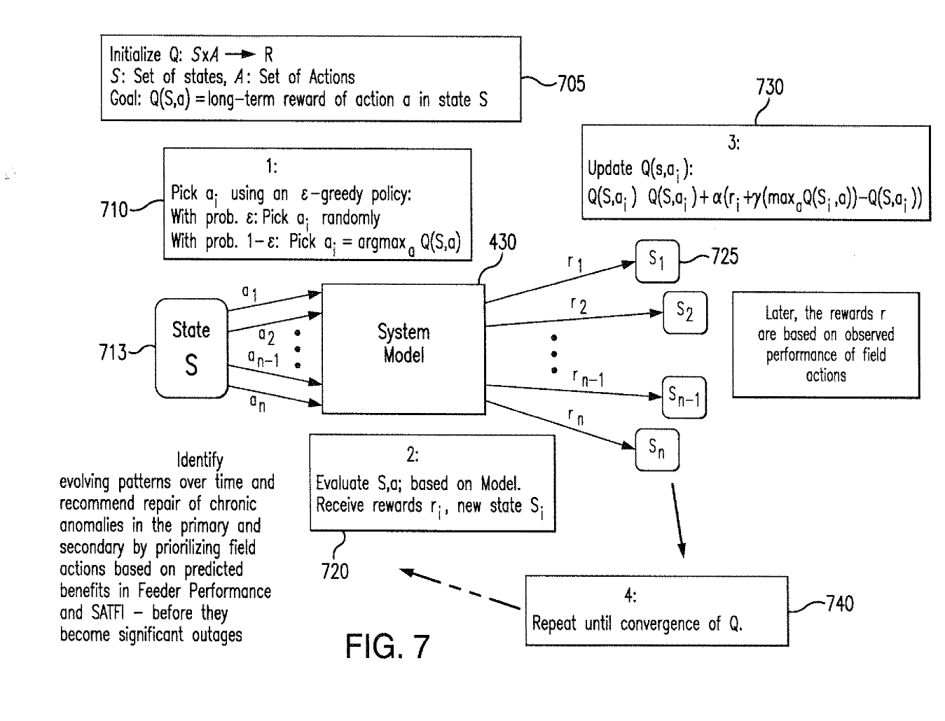

For purposes of illustration and not limitation, an exemplary learning method 470, which can be referred to as “Q-learning,” for the approximate dynamic programming element 440 will now be described with reference to FIG. 7. The learning method can first be initialized 705 with Q:S×A→R, where S is a set of states and A is a set of available actions 450. The Q-learning algorithm can seek a long-term reward of action a in state S. First, an action aᵢ is selected 710 using an ε-greedy method. That is, aᵢ can be selected at random with probability ε, and can be selected to satisfy arg maxₐ Q(S, a) with probability (1−ε). (S,aᵢ) can then be evaluated 720 based on one or more models 430 of the adaptive stochastic controller 410, so as to receive a reward rᵢ and new state Sᵢ. Q(s,aᵢ) can then be updated 730 such that:

Q(S,aᵢ)=Q(S,aᵢ)+α(rᵢ+γ(maxₐQ(Sᵢ,a))−Q(S,aᵢ)). (2)

Additionally or alternatively, approximate or parameterized Q-learning can be employed, in which the Q-function can be approximate, and wherein not every state-action pair is stored explicitly due to the large number of state-action pairs possible.

Selecting 710, evaluating 720, and updating 730 can be repeated 740 until Q converges. That is, for example, for each state S 713, the one or more models 430 can be used to evaluate the selected action, giving a set of updated states 725.

The presently disclosed subject matter is not to be limited in scope by the specific embodiments herein. Indeed, various modifications of the disclosed subject matter in addition to those described herein will become apparent to those skilled in the art from the foregoing description and the accompanying figures. Such modifications are intended to fall within the scope of the appended claims.

1. A system for generating a dynamic treatment control policy for a cyber-physical system having one or more components, comprising:
a data collector to collect data representative of the cyber physical system; and
an adaptive stochastic controller operatively coupled to the data collector and adapted to receive collected data therefrom, the adaptive stochastic controller comprising:
one or more models for generating a predicted value corresponding to one or more available actions based on an objective function;
an approximate dynamic programming element, configured to receive one or more actual operation metrics corresponding to one of the available actions and to learn a state-action map; and
wherein the adaptive stochastic controller is adapted to generate a dynamic treatment control policy using the one or more models.

2. The system of claim 1, wherein the approximate dynamic programming element is further configured to adjust the one or more models using the actual operation metrics.

3. The system of claim 1, wherein the data collector includes a receiver for receiving outage derived data sets and the collected data includes one or more of static data about the components, dynamic external data, and dynamic data about the components.

4. The system of claim 1, wherein the objective function comprises a mean time between failure, and wherein the one or more models for generating a predicted value includes a model for generating a predicted mean time between failure for each component of the cyber-physical system.

5. The system of claim 4, wherein the model is further configured to calculate a predicted metric based on a gradient of a failure rate for each component, the predicted metric being the difference in failure rate.

6. The system of claim 4, wherein the model is further configured to calculate the predicted mean time between failure based on a semiparametric model.

7. The system of claim 1, wherein the one or more models further includes a propensity model for inversely weighting components with a history of independent treatment using the data representative of the cyber-physical system.

8. The system of claim 1, wherein the one or more models further includes a learning system for learning behavior of the cyber-physical system and learn a state-action map and optionally adjusting the one or more models using the one or more actual operation metrics.

9. The system of claim 1, wherein the approximate dynamic programming element is further configured to learn the state-action map and optionally adjust the one or more models using Q-learning for comparison of the predicted value and the one or more actual operation metrics.

10. The system of claim 1, wherein the available actions is selected from the group consisting of repairing, replacing, or delaying repairing or replacing one or more components of the cyber-physical system.

11. The system of claim 1, wherein the available actions is selected from the group consisting of repairing, replacing, or deciding not to repair or replace one or more components of the cyber-physical system in an order determined by the one or more models.

12. The system of claim 1, wherein the actual operation metrics is selected from the group consisting of recorded data of the components, estimated data of the components, and external data.

13. A method for generating a dynamic treatment control policy for a cyber-physical system having one or more components, where one or more available actions on each of the one or more components can be taken, comprising:
generating a predicted value corresponding to the one or more available actions based on an objective function and using one or more models using data representative of the cyber-physical system;
receiving one or more actual operation metrics at an approximate dynamic programming element, the actual operation metrics corresponding one or more executed actions, the one or more executed actions corresponding to one of the one or more available actions;
learning a state-action map with the approximate dynamic programming element using the actual operation metrics; and
generating a dynamic treatment control policy using the predicted value and the one or more models.

14. The method of claim 13, further comprising adjusting the one or more models with the approximate dynamic programming element using the actual operation metrics; and

15. The method of claim 13, further comprising transmitting the data representative of the cyber-physical system from an outage derived data set to the one or more models, and wherein the data representative of the cyber-physical system includes one or more of static data about the components, dynamic external data, and dynamic data about the components.

16. The method of claim 13, wherein the objective function comprises a mean time between failure and wherein generating a predicted value includes using a model generating a predicted mean time between failure for each component of the cyber-physical system.

17. The method of claim 16, wherein using one or more models further comprises using a model configured to calculate a predicted metric based on a gradient of a failure rate for each component, the predicted metric being the difference in failure rate.

18. The method of claim 16, wherein using one or more models further comprises using a model configured to calculate the predicted mean time between failure based on a semiparametric model.

19. The method of claim 13, wherein generating a predictive value further comprises inversely weighting components with a history of independent treatment using the data representative of the cyber-physical system.

20. The method of claim 13, wherein adjusting the one or more models further comprises learning a behavior of the cyber-physical system, learning the state-action maps, and optionally adjusting using the behavior and the one or more actual operation metrics.

21. The method of claim 13, wherein the adjusting further includes learning the state-action map and optionally adjusting the one or more models using Q-learning for comparison of the predicted value and the one or more actual operation metrics.

22. The method of claim 13, wherein the one or more available options is selected from the group consisting of repairing, replacing, or delaying repairing or replacing one or more components of the cyber-physical system, and further comprising executing the one or more available options.

23. The method of claim 13, wherein the actual operation metrics is selected from the group consisting of the components, estimated data of the components, and external data, and further comprising:
collecting the actual operation metrics; and
transmitting the actual operation metrics to the approximate dynamic programming element.
